(19) United States
(12) Patent Application Publication
(10) Pub. No.: US 2021/0299973 A1
(43) Pub. Date: Sep. 30, 2021

(54) MAT AND METHOD TO MANUFACTURE MAT

(71) Applicant: Chun-Fu KUO, Taichung City (TW)

(72) Inventor: Chun-Fu KUO, Taichung City (TW)

(21) Appl. No.: 17/346,609

(22) Filed: Jun. 14, 2021

Related U.S. Application Data
(63) Continuation-in-part of application No. 16/231,894, filed on Dec. 24, 2018.
Application No. 16/231,894 is a continuation-in-part of application No. 15/404,695, filed on Jan. 12, 2017, now abandoned.

(51) Int. Cl. B29C 69/00

(52) U.S. Cl. CPC B29C 69/001; B29K 2021/00

(57) ABSTRACT

The mat of the present invention includes a main body integrally formed by a plastic material. The main body at least has a first surface and a second surface adjacent to the first face. The first face and the second face have different surface physical characteristics. The first surface and the second surface are shaped into a third surface and a fourth surface respectively. The third surface and the fourth surface have a substantially same surface physical characteristic. An angle between the third surface and the fourth surface outside the main body is a specific value.

The present invention is a CIP of application Ser. No. 16/231,894, filed Dec. 24, 2018, which is a CIP of application Ser. No. 15/404,695, filed Jan. 12, 2017, the entire contents of which are hereby incorporated by reference.

### BACKGROUND OF THE INVENTION

### Field of the Invention

### Description of the Prior Art

Generally, mats made of rubber are manufactured by placing rubber material in a mold to shape. To manufacture mats in various sizes and shapes, molds having various sizes and shapes have to be prepared. Thus, the cost is high. Especially, the cost is increased when the mats are manufactured in a small amount.

Besides, to manufacture a mat having a slight difference in angle, different molds have to be prepared. Thus, cost of stock is hardly reduced.

US2016/0037949 discloses that the outer surface is formed by adhering with sheets, instead of being integrally formed. Thus, US2016/0037949 fails to disclose that the main body integrally formed by plastic material has a third surface and a fourth surface having different mean surface roughnesses.

Similarly, U.S. Pat. No. 6,921,502 discloses that the outer surface is formed by adhering with sheets, instead of being integrally formed, and thus it fails to disclose that the main body integrally formed by plastic material has a third surface and a fourth surface having different mean surface roughnesses.

US2016/0037949 describes varying the surface roughness between two surfaces. However, US2016/0037949 does not disclose that the shaping reduces differences between the two surfaces.

### SUMMARY OF THE INVENTION

The main object of the present invention is to provide a mat which is easy to be manufactured in various sizes.

To achieve the above and other objects, a mat of the present invention includes a main body integrally formed by a plastic material. The main body at least has a first surface and a second surface adjacent to the first face. The first face and the second face have different surface physical characteristics. The first surface and the second surface are shaped into a third surface and a fourth surface respectively. The third surface and the fourth surface have a substantially same surface physical characteristic. An angle between the third surface and the fourth surface outside the main body is a specific value.

To achieve the above and other objects, a method to manufacture mat of the present invention includes the following steps.

Shaping: shaping a main body with a plastic material with a mold. The main body at least has a first surface.

Cutting: cutting out a part of the main body to form a second surface. A surface physical characteristic of the second surface is different from that of the first surface. The second surface is adjacent to the first surface.

Shaping again: the first surface and the second surface under surface processing so that a third surface and a fourth surface are formed from the first surface and the second surface respectively wherein the third surface and the fourth surface have substantially same surface physical characteristics. An angle between the third surface and the fourth surface outside the main body is a specific value.

Thereby, the mat can be manufactured into various sizes and shapes without preparing various molds.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a mat of the present invention during a step of shaping.

FIG. 1a is a stereogram of a mat of the present invention during a step of cutting.

FIG. 1b is a stereogram of a mat of the present invention during a step of shaping again.

FIG. 2 is a partial cross-section of a mat of the present invention during a step of shaping.

FIG. 2a is a partial cross-section of a mat of the present invention during a step of cutting.

FIG. 2b is a partial cross-section of a mat of the present invention during a step of shaping again.

FIG. 3 is a partial stereogram of a mat according to another embodiment of the present invention.

FIG. 4 is a partial enlargement of FIG. 3.

### DETAILED DESCRIPTION OF THE PREFERRED EMBODIMENTS

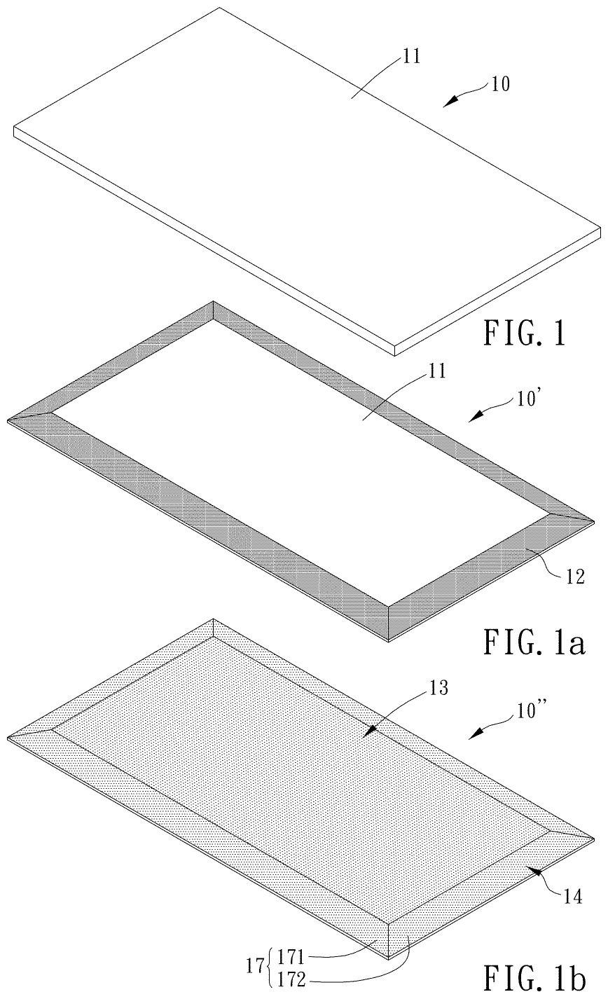

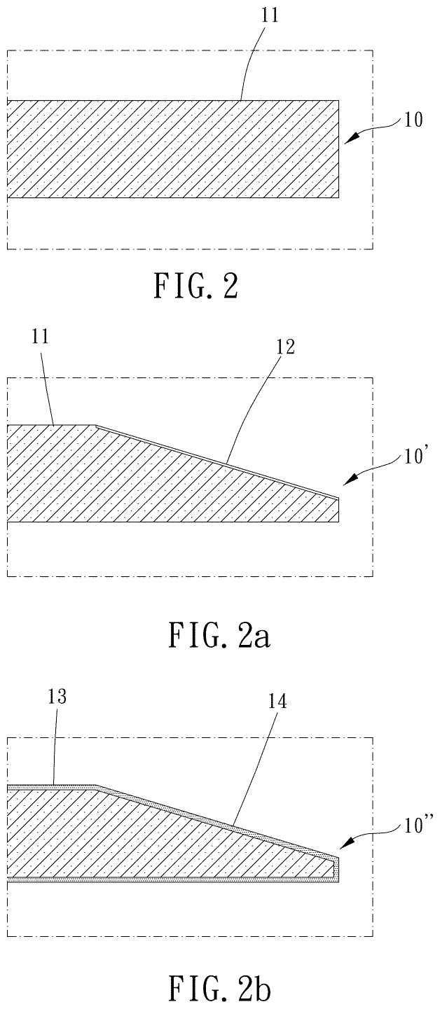

Please refer to FIGS. 1 to 2b, the mat of the present invention includes a main body 10 integrally formed by a plastic material, such as rubber or rubber composite to be soft and resilient. The main body 10 at least has a first surface 11 and a second surface 12 adjacent to the first surface 11. The first surface 11 has a surface physical characteristic, such as mean surface roughness, different from that of the second surface 12. The first surface 11 and the second surface 12 are shaped into a third surface 13 and a fourth surface 14 respectively wherein the third surface 13 and the fourth surface 14 have different surface physical characteristic such as mean surface roughness. However, the surface physical characteristics of the third surface 13 and the fourth surface 14 can have extremely slight differences. An angle between the third surface 13 and the fourth surface 14 outside the main body 10″ is preferably larger than 180 degrees but not larger than 270 degrees so that the fourth surface 14 is an inclined face with respect to the third surface 13.

In the present embodiment, the mat is cuboid and having a top face and a bottom face. A circumferential face including four lateral faces connects the top face and the bottom face therebetween. The first surface 11 is located on the top face, and the second surface 12 is located on each of the lateral faces. Preferably, a plurality of bumps formed integrally on the main body 10 are distributed over the third surface 13 and the fourth surface 14. For example, the bumps can be formed by a mold whose inner surface having a plurality of holes.

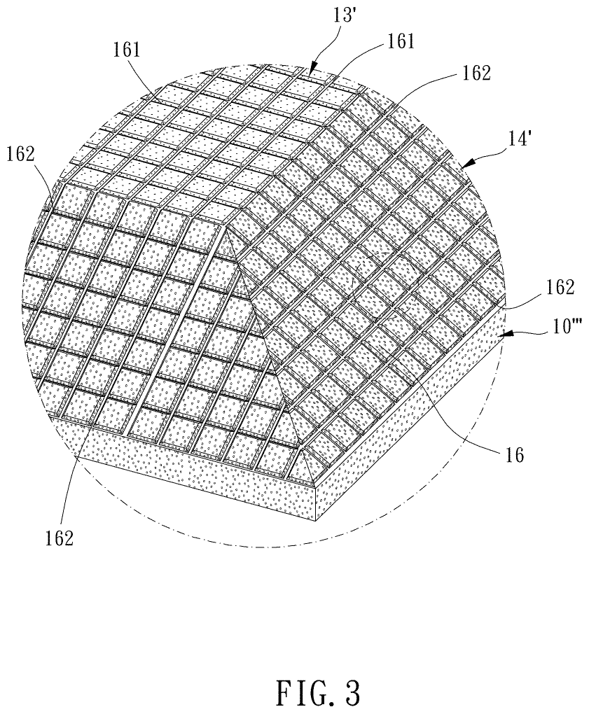

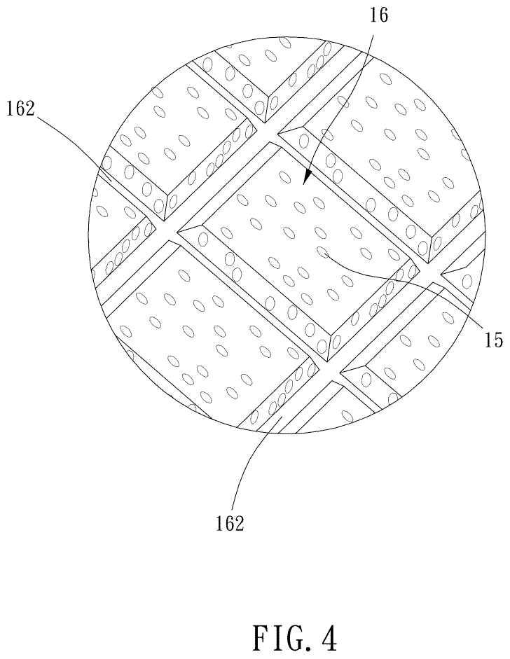

Specifically, as shown in FIGS. 3 and 4, the main body 10′″ is integrally formed of one piece, and the third surface 13′ and the fourth surface 14′ are integrally formed as parts of the main body 10′″. Depending on different processing such as embossing, calendering, grinding, cutting, hot-press, before or after the third surface 13′ and the fourth surface 14′ are completed, at least one of the mean surface roughnesses of the third surface 13′ and the fourth surface 14′ is between 0.08 μm to 80 μm. The main body 10′″ is a foamed member and further includes a plurality of open cells 15 which are disposed on at least one of the third surface 13′ and the fourth surface 14′; however, the main body may be a solid member. An area of the fourth surface 14′ on which the plurality of open cells 15 are distributed is at least 15% of a total area of the fourth surface 14′. The plurality of open cells 15 may be disposed on the third surface 13′ and the fourth surface 14′, and an amount of the open cells 15 distributed on the fourth surface 14′ is greater than an amount of the open cells 15 distributed on the third surface 13′. Preferably, the open cell 15 distributed on the fourth surface 14′ has a pore size greater than that of the open cell 15 distributed on the third surface 13′. At least one of the third surface 13′ and the fourth surface 14′ further includes a plurality of bumps 16 integrally formed thereon, and the plurality of open cells 15 are distributed on at least part or all of the plurality of bumps 16. The mean surface roughness of the fourth surface 14′ is preferably at least 1.10 times the mean surface roughness of the third surface 13′.

The present invention also provides a method to manufacture mat including the following steps.

Shaping: shaping a main body 10 from a plastic material by a mold. The main body 10 at least has a first surface 11. In the present embodiment, the plastic material is rubber or rubber composite to be soft and resilient.

Cutting: the main body 10′ is formed by cutting out a part of the main body 10 to form a second surface 12 having a surface physical characteristic different from that of the first surface 11, such as surface roughness. For example, a mean surface roughness of the second surface 12 is different from that of the first surface 11. The main body is cut to form the second surface of the mean surface roughness between 0.08 μm to 80 μm. The second surface 12 is adjacent to the first surface 11. In the present embodiment, the mat is cuboid and having a top face and a bottom face. Four lateral faces connect the top face and the bottom face therebetween. The first surface 11 is located on the top face, and the second surface 12 is located on each of the lateral faces. The main body is selected from a foamed member, and after the step of cutting, a plurality of open cells are distributed on the second surface.

Shaping again: the first surface 11 and the second surface 12 are under surface processing to vary the surface physical characteristics of the first and second surfaces 11, 12 and to lower the mean surface roughness of the second surface 12 so that a third surface 13 and a fourth surface 14 are formed from the first surface and the second surface respectively wherein the third surface 13 and the fourth surface 14 have different surface physical characteristics. Specifically, differences of mean surface roughnesses between the third and fourth surfaces 13, 14 are reduced to be smaller than differences of the mean surface roughnesses between the first and second surfaces 11, 12. After the second shaping, at least one of the third surface 13 and the fourth surface 14 is shaped to have the mean surface roughness between 0.08 μm to 80 μm. An angle between the third surface 13 and the fourth surface 14 outside the main body 10″ is preferably larger than 180 degrees but not larger than 270 degrees. Preferably, the first surface 11 and the second surface 12 are heated and compressed with a mold having at least one pattern to form the third surface 13 and the fourth surface 14. After the step of shaping again, the third surface and the fourth surface are shaped so that an amount of the open cells distributed on the fourth surface is greater than an amount of the open cells distributed on the third surface. It is noted that there may be none of open cell distributed on the third surface.

Specifically, during the step of shaping, the plastic material is incompletely cross-bridged. However, during the step of shaping again, the plastic material is fully cross-bridged to form the third surface 13 and the fourth surface 14. Besides, a plurality of bumps are integrally formed on the third surface 13 and the fourth surface 14 to make the surface physical characteristics of the third surface 13 and the fourth surface 14 more similar to each other. For example, the bumps are formed by a mold whose inner surface having a plurality of holes. A part of the plurality of bumps 16 are formed to define a plurality of first grooves 161 on the third surface 13, another part of the plurality of bumps 16 are formed to define a plurality of second grooves 162 on the fourth surface 14, and the plurality of second grooves 162 are communicated with the plurality of first grooves 161. Each of the plurality of first grooves 161 is formed to have a depth less than a width of respective one of the plurality of bumps 16. The circumferential face 17 of the mat includes a plurality of lateral side faces 171 and 172, neighboring two of the plurality of lateral side faces 171 and 172 are angularly connected with each other, and parts of the plurality of second grooves 162 on the neighboring two of the plurality of lateral side faces 171 and 172 are communicated with each other.

In conclusion, the step of cutting is advantageous that the size or shape of the mat can be modified. Thus, the main body can be manufactured to mats in various sizes and shapes so that it is not necessary to prepare molds in various sizes and shapes. Therefore, the cost can be reduced, and the mat can be manufactured in a small amount. That is, the cost of stock can be reduced.

What is claimed is:

1. A method to manufacture mat, including:
first shaping: shaping a main body with a plastic material with a mold to form the main body of one piece, the main body at least having a first surface;
cutting: cutting out a part of the main body to form a second surface, a mean surface roughness of the second surface being different from that of the first surface;
second shaping: the first surface and the second surface under surface processing to vary the surface physical characteristics of the first and second surfaces and to lower the mean surface roughness of the second surface so that a third surface and a fourth surface are formed from the first surface and the second surface respectively and so that differences of mean surface roughnesses between the third and fourth surfaces are reduced to be smaller than differences of the mean surface roughnesses between the first and second surfaces, and an angle between the third surface and the fourth surface outside the main body being a specific value.

2. The method to manufacture mat of claim 1, wherein the angle between the third surface and the fourth surface outside the main body is larger than 180 degrees but not larger than 270 degrees.

3. The method to manufacture mat of claim 2, wherein the mat is cuboid and has a top face, a bottom face and a circumferential face connecting the top face and the bottom face, the first surface is located on the top face, and the second surface is located on the circumferential face.

4. The method to manufacture mat of claim 1, wherein the plastic material is selected from a group composed of rubber and rubber composite, and the plastic material is soft and resilient.

5. The method to manufacture mat of claim 1, wherein the plastic material is incompletely cross-bridged in the first shaping, and the plastic material is fully cross-bridged in the second shaping.

6. The method to manufacture mat of claim 1, wherein the main body is cut to form the second surface of a mean surface roughness between 0.08 μm to 80 μm, and the mean surface roughness of the second surface is different from that of the first surface.

7. The method to manufacture mat of claim 6, wherein in the second shaping, at least one of the third surface and the fourth surface is shaped to have a mean surface roughness between 0.08 μm to 80 μm.

8. The method to manufacture mat of claim 1, wherein in the second shaping, the first surface and the second surface are heated and compressed with a mold having at least one pattern to form the third surface and the fourth surface.

9. The method to manufacture mat of claim 8, wherein in the second shaping, a plurality of bumps are formed on the main body and distributed on the third surface and the fourth surface.

10. The method to manufacture mat of claim 1, wherein the main body is a foamed member, and after the step of cutting, a plurality of open cells are distributed on the second surface.

11. The method to manufacture mat of claim 10, wherein after the second shaping, an amount of the open cells distributed on the fourth surface is greater than an amount of the open cells distributed on the third surface.

12. The method to manufacture mat of claim 9, wherein a part of the plurality of bumps are formed to define a plurality of first grooves on the third surface, another part of the plurality of bumps are formed to define a plurality of second grooves on the fourth surface, and the plurality of second grooves are communicated with the plurality of first grooves.

13. The method to manufacture mat of claim 12, wherein each of the plurality of first grooves is formed to have a depth less than a width of respective one of the plurality of bumps.

14. The method to manufacture mat of claim 12, wherein the mat is cuboid and has a top face, a bottom face and a circumferential face connecting the top face and the bottom face, the first surface is located on the top face, the second surface is located on the circumferential face, the circumferential face includes a plurality of lateral side faces, neighboring two of the plurality of lateral side faces are angularly connected with each other, and parts of the plurality of second grooves on the neighboring two of the plurality of lateral side faces are communicated with each other.
